(19) United States
(12) Patent Application Publication
(10) Pub. No.: US 2002/0140549 A1
(43) Pub. Date: Oct. 3, 2002

(54) Telephone controlled vehicle intrusion sensor and report apperatus

(76) Inventor: Po-Chien Tseng, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/820,614

(22) Filed: Mar. 30, 2001

(51) Int. Cl. B60R 25/10; G08B 1/08; H04Q 7/00; G08C 19/00

(52) U.S. Cl. 340/426; 340/539; 340/825.72

(57) ABSTRACT

Telephone controlled vehicle intrusion sensor and report apparatus is operatable by calling from an wired phone or a cellular phone to a vehicle radio phone to start the vehicle air conditioner and set up the vehicle alarm system in watching state, and also the apparatus is able to report to the owner the present situation about the vehicle by the vehicle radio phone remotely even from an underground parking lot.

### BACKGROUND OF THE INVENTION

1. Field of the invention

The present invention relates to telephone controlled vehicle intrusion sensor and report apparatus, in particular, the apparatus is operatable by calling from an wired phone or a wireless cellular phone to a wireless phone controlled in the vehicle to start the vehicle air conditioner and set up the vehicle alarm system on work, also the apparatus is capable of reporting the present state such as temperature of the vehicle etc. to the owner through the vehicle wireless phone.

2. Description of the Prior Art

There were several patents offered to inventions concerning to remote control of vehicles in Taiwan ROC. For example, “Remote Control System for Vehicle Air Conditioner” (95297). “Automatic Remote Control for Vehicle Indoor Temperature” (96299), and “Remote Control System for Preheating and Starting Automobile Engine”. In all these cited cases, they are commonly characterized in that the remote control device formed in compliance with FCC standards is used. However, such a remote control device has several shortcomings:

1. Available control distance is only as short as 10˜50 yards that discourages intention of the owners to use.

2. If it is desired to lengthen the controllable distance, power of the device must be increased which causes the device become bulky or cause radio interference.

3. No report facility results in that the owner away from his/her vehicle is unable to be notified of the present vehicle state.

In order to overcome the shortcomings inherent to the conventional technique described above, the present inventor has delved into this matter with a long time efforts and came to realization of the present invention.

### SUMMARY OF THE INVENTION

Therefore, the present invention is aimed to provide telephone controlled vehicle intrusion detection and report apparatus which is operatable by calling from an wired phone or a wireless cellular phone to a wireless phone control module in the vehicle to start the vehicle air conditioner and set up the vehicle alarm system to work, also the apparatus is made capable of reporting the present state, such as inside temperature of the vehicle etc., to the caller far apart from his/her vehicle through the wireless phone installed in the vehicle.

To achieving the above mentioned objects, in the present invention, the vehicle intrusion sensor and electronic doorlock can be controlled remotely by the owner's cellular phone instead of carrying a string of individual remote controllers along with. In addition, the vehicle air conditioner can be started by an owner's calling to the vehicle phone via a wired phone or a cellular phone from far distance. Besides, the effective operational distance of the present invention covers a wide range and even functional in underground parking lots.

For fuller understanding of the nature and objects of the present invention, reference should be made to the following detailed description taken in conjunction with the accompanying drawings.

### BRIEF DESCRIPTION OF THE DRAWINGS

FIG. 1 is a circuit block diagram for illustration of the present invention;

FIG. 2 is a flow chart of operation of the present invention; and

FIG. 3 is a flow chart illustrating the program flow of the present invention when interrupted on sensing abnormal signal from the vehicle door.

### DETAILED DESCRIPTION OF THE PREFERRED EMBODIMENT

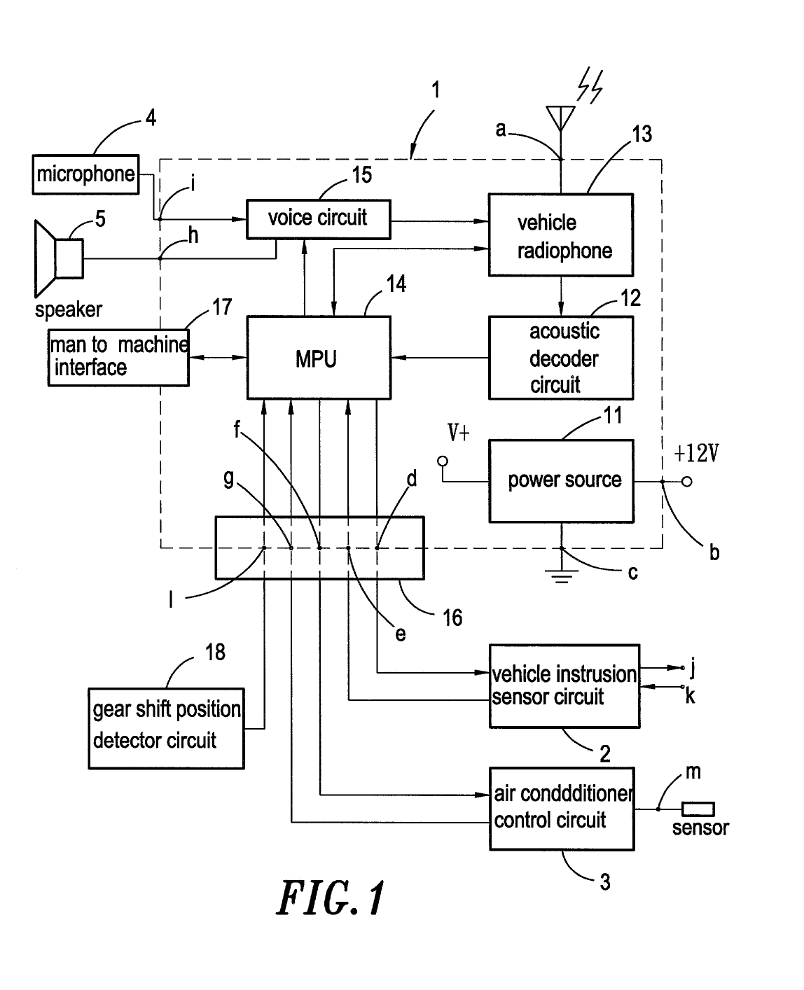

FIG. 1 is a circuit block diagram of the present invention. It shows that the apparatus of the present invention comprises a power source 11 for supplying stable electrical power to the present invention; an acoustic decoder circuit 12 for decoding a multi-frequency control signal received, and sending the decoded signal to a MPU; a vehicle wireless phone 13 for receiving control signals from a wired phone or a cellular phone, and for transmitting an intrusion alarm or a return signal; a MPU 14 composing of a CPU, a RAM, a ROM, an output port, and an input port, the ROM is a program storage area wherein data treated by CPU and the RAM is outputted via the output port or read in via the input port; a voice circuit 15 for inputting a plurality of pre-recorded report voice combination from a microphone, and reporting to the owner via a speaker 5 or a vehicle wireless phone 13 according to classification made by the MPU 14 at appropriately predetermined delivery timing; an interface for output/input control 16 for sending a two-way information signal of the MPU 14 to a vehicle intrusion sensor circuit 2 and an air conditioner controller 3; a man to machine interface 17 for enabling the owner to input parameters for the present system with an input equipment. Meanwhile, the MPU 14 stays in waiting and watching state after being activated, as soon as the vehicle wireless phone 13 has received a phone call from the owner, the signal is decoded by the acoustic decoder circuit 12 and sent to the MPU 14 for identifying. If it is a valid signal to be true, then the signal enters the voice circuit 15 for selecting a relevant order which starts the engine by actuating an electric key through the interface 16, at the same time the air conditioner 3 is set at a predetermined temperature. In case a vehicle intrusion sensor circuit 2 is not released from its watching duty according to a normal procedure during the engine is under energized state, a signal is sent to the MPU 14 from the acoustic decoder circuit 12 and the information is reported to the owner via the voice circuit 15 and the vehicle wireless phone 13. The phone call signal received by the vehicle wireless phone 13 is decoded by the acoustic decoder circuit 12 before transmitting the signal to MPU for identifying. If the signals are judged to be false successively for more than three times, the MPU 14 disconnects the communication with the vehicle wireless phone 13 at once and reports to the owner via voice circuit 15.

In case the vehicle intrusion sensor circuit 2 receives an abnormal vehicle door signal or other alarm signals, the signals are transmitted to the MPU 14 through the interface 16 for judgement immediately, and the information is reported to the owner by the vehicle radio phone 13 via voice circuit 15 at once.

In the present invention the input equipment to the man-machine interface 17 can be a wired or a wireless phone, or in voice control form for inputting related parameters, and the voice is outputted from the speaker 5 via voice circuit 15.

Meanwhile, in the present invention, a gear shift position detector circuit 18 is provided for sending an terminal signal to the output/input control interface 16 for detecting if the gear is shifted to P or N position in an automatic gear shift vehicle or to the neutral position in a manual gear shift vehicle so as to make sure if the vehicle is securely parked.

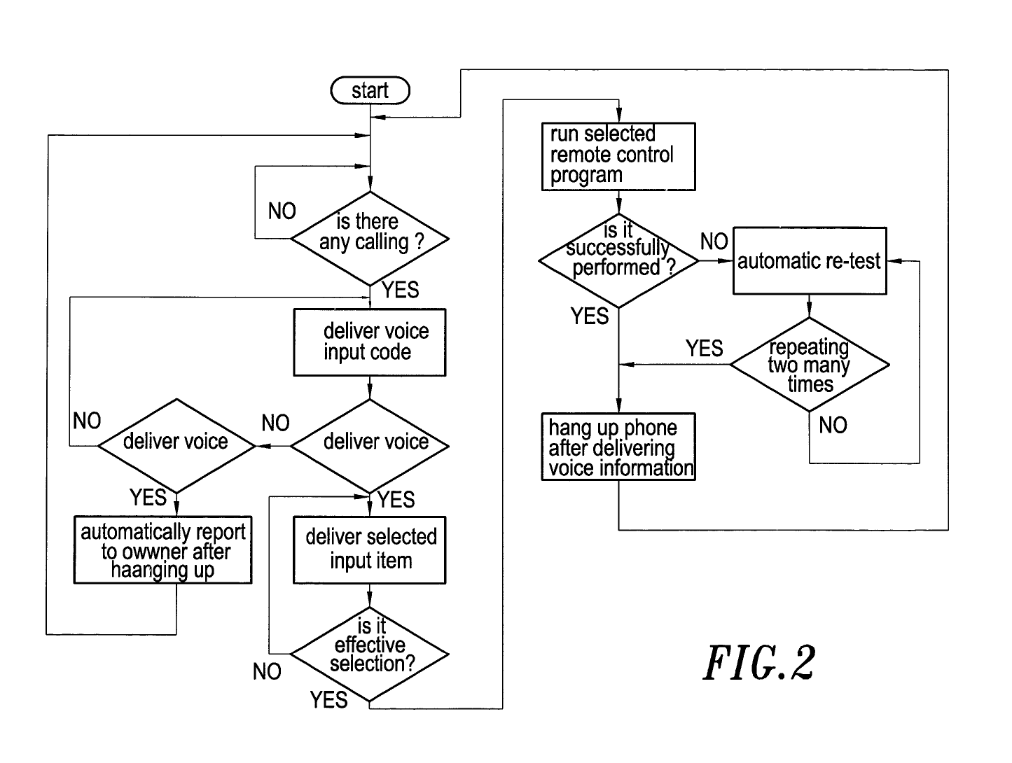

FIG. 2 is a flow chart of operation of the present invention. The apparatus of the present invention is set up in waiting and watching state after being activated. As soon as the vehicle wireless phone has received a phone call from the owner, the signal is decoded by the acoustic decoder circuit and if it is identified to be correct, then the signal enters the voice circuit for selection of a relevant input which starts the engine by controlling an electric key through the output/input control interface, at the same time the air conditioner is set at a predetermined temperature. If the signal is judged to be false for more than three times, the communication with the vehicle wireless phone is disconnected at once and the owner gets an immediate report about this situation.

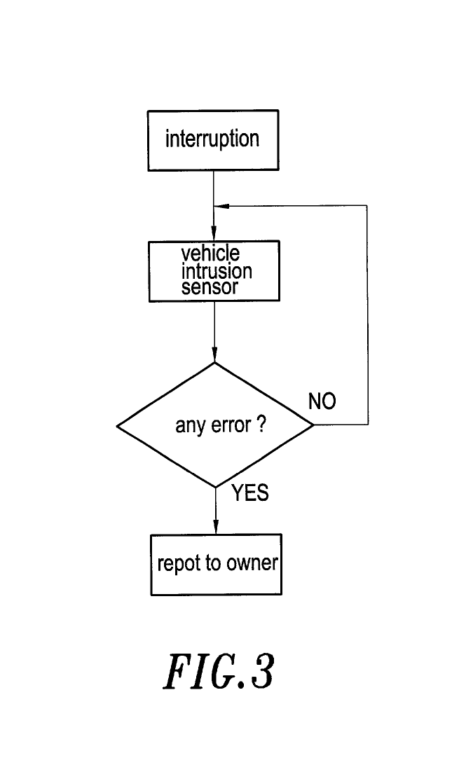

FIG. 3 is a flow chart illustrating that the running of the program is interrupted upon sensing an abnormal signal from the vehicle door sensor. After interruption of the program, the present situation is immediately reported to the owner by the vehicle radio phone through the voice circuit.

After having finished reading over the above detailed description of the present invention, one may clearly understand that the present invention has several noteworthy features which are distinctly superior to the three cited prior cased described above namely:

1. According to the present invention, the vehicle intrusion sensor and the electronic doorlock can be controlled by the owner's cellular phone instead of carrying a string of individual remote controllers along with.

2. According to the present invention, the vehicle air conditioner can be started by an owner's calling to the vehicle phone via a wired phone or a cellular phone distantly.

3. According to the present invention, it is capable of reporting the present state, including inside temperature of the vehicle to the owner who is far apart from the vehicle.

4. According to the present invention, the effective operational distance of the apparatus covers a wide range even functionable in underground parking lots.

While it will be apparent that the preferred embodiment of the invention is well calculated to provide the advantage and feature above stated, it will be appreciated that the invention is susceptible to modification, variation and change without departing from the proper scope or fair meaning of the subjoined claims.

What is claimed is:

1. Telephone controlled vehicle intrusion detection and report apparatus comprising:
a power source for supplying stable electrical power to said apparatus;
an acoustic decoder circuit for decoding a multi-frequency control signal received, and sending said decoded signal to a MPU;
a vehicle wireless phone for receiving control signals from a wired phone or a cellular phone, and transmitting an intrusion alarm or a return signal to the owner;
a MPU composing of a CPU, a RAM, a ROM, an output port, and an input port, said ROM being a program storage area wherein data treated by said CPU and said random memory being outputted via said output port or read in via said input port;
a voice circuit for inputting a plurality of pre-recorded report voice combination from a microphone, and reporting to the owner via speaker or a vehicle radio phone according to classification made by said MPU at relevantly predetermined delivery timing;
an output/input control interface for sending therefrom a two-way information signal of said MPU to a vehicle intrusion sensor circuit and an air conditioner controller; and
a man to machine interface for enabling the owner to input parameters for the present system by means of an input equipment;
wherein said MPU stays in waiting and watching state after being energized, as soon as said vehicle radio phone has received a call from the owner, the signal is decoded by said acoustic decoder circuit and sent to said MPU for identifying, if it is acknowledged to be true, then the signal enters said voice circuit for selecting a relevant order which starts the engine by actuating an electric key through said output/input control interface, at the same time, the vehicle air conditioner is set at a predetermined temperature, in case said vehicle intrusion sensor circuit is not released from its watching duty according to a normal procedure during the engine is working, a signal is sent to said MPU from said acoustic decoder circuit and the information is reported to the owner via said voice circuit and said vehicle radio phone.

2. The apparatus of claim 1, wherein said phone call signal received by said vehicle radio phone is decoded by said acoustic decoder circuit before transmitting said signal to said MPU for identifying, if the signals are judged to be false successively for more than three times, said MPU disconnects the communication with said vehicle radio phone at once and reports to the owner via said voice circuit.

3. The apparatus of claim 1, wherein in case said vehicle intrusion sensor circuit receives an abnormal vehicle door signal or other alarm signals, said signals are transmitted to said MPU through said output/input control interface for judgment immediately, and such information is reported to the owner by said vehicle radio phone via said voice circuit.

4. The apparatus of claim 1, wherein said input equipment is a wired or a radio phone, or in any voice control form for inputting related parameters, and the voice is outputted from said speaker via said voice circuit.
